(19) United States
(12) Patent Application Publication
(10) Pub. No.: US 2005/0122645 A1
(43) Pub. Date: Jun. 9, 2005

(54) ESD protection design against charge-device model ESD events

(75) Inventors: Ming-Dou Ker, Hsinchu (TW); Kun-Hsien Lin, Hsinchu (TW)

Correspondence Address: Shaw Pittman L.L.P., 1650 Tysons Blvd., McLean, VA, 22102, US

(73) Assignee: Industrial Technology Research Institute, Hsinchu (TW)

(21) Appl. No.: 10/726,641

(22) Filed: Dec. 4, 2003

(51) Int. Cl. H02H 9/00

(52) U.S. Cl. 361/56

(57) ABSTRACT

An interface device coupled to a board on which integrated circuits are mounted for providing electrostatic discharge protection for the integrated circuits that comprises a plurality of first contact members, each of the first contact members including one end connected to the board and the other end to connect to an external device, and at least one second contact member connected to a voltage line of a voltage level, wherein the at least one second contact member includes a length greater than that of each of the first contact members.

### DESCRIPTION OF THE INVENTION

1. Field of the Invention

This invention pertains in general to circuits and methods for electrostatic discharge (“ESD”) protection and, more particularly, to circuits and methods for a charged-device model (“CDM”) ESD protection.

2. Background of the Invention

A semiconductor integrated circuit (“IC”) is generally susceptible to an electrostatic discharge (“ESD”) event, which may damage or destroy the IC. An ESD event refers to a phenomenon of electrical discharge of a current (positive or negative) for a short duration during which a large amount of current is provided to the IC. The susceptibility of a device to ESD can be determined by testing for one of three models, Human Body Model (HBM), Machines Model (MM), and Charged-Device Model (CDM).

The ESD Association Standard for the Development of an Electrostatic Discharge Control Program for Protection of Electrical and Electronic Parts, Assemblies and Equipment (Excluding Electrically Initiated Explosive Device), ANSI/ESD-S20.20-1999 (Aug. 4, 1999), provides for ESD sensitivity testings for each of the three models. The HBM model represents the discharge from the fingertip of a standing individual delivered to conductive leads of a device. In an HBM model ESD test circuit, modeled by a 100 picofarad (pF) capacitor, representing the effective capacitance of the human body, discharged through a switching component and 1,500 ohm series resistor, representing the effective resistance of the human body, into the device under tests, the discharge is a double exponential waveform with a rise time of 2-10 nanoseconds (nS) and a pulse duration of approximately 150 nS.

The MM model represents a rapid discharge from items such as a charged board assembly, charged cables, or the conduction arm of an automatic tester. The effective capacitance is approximately 200 pF discharged through a 500 nanohenry (nH) inductor directly into the device because the effective resistance of the machine is approximately zero. The discharge is a sinusoidal decaying waveform having a peak current of approximately 3.8 amperes (A) with a resonant frequency of approximately 16 MHz.

The CDM model is a phenomenon when a device acquires a charge through frictional or electrostatic induction processes and then abruptly touches a grounded object or surface. Most of the charge is accumulated in a substrate, including a base, a bulk or a well of the device, and is uniformly distributed in the substrate. Unlike the HBM model and the MM model, the CDM model includes situations where the device itself becomes charged and discharges to ground. The rise time is generally less than 200 picoseconds (pS), and the entire ESD event can take place in less than 2 nS. Current levels can reach several tens of amperes during discharge.

Many schemes have been implemented to protect an IC from the CDM ESD events. Examples of the conventional schemes include U.S. Pat. Nos. 6,462,601 and 5,729,419 (hereinafter the '601 and '419 patents, respectively). The '601 patent to Chang, entitled “Electrostatic Discharge Protection Circuit Layout,” discloses a first and second CDM ESD protection devices formed in a discharging loop to discharge ESD current during an ESD event. The '419 patent to Lien, entitled “Charged Device Model Electrostatic Discharge Protection Circuit for Output Drivers and Method of Implementing Same,” discloses a CDM ESD clamp circuit formed between an output of a pre-driver circuit and an output pad to clamp a CDM ESD overstress voltage across a gate oxide of an output NMOS/PMOS (n-type or p-type metal-oxide-semiconductor transistor) device.

The above-mentioned ESD protection schemes, however, are designed to increase ESD immunity of individual chips, and may not provide sufficient protection for the chips under a board-level CDM ESD event. Generally, the ICs of a system are mounted on a board coupled to another system through a connector. The connector includes a plurality of pins or plugs typically of a same length connected to ground. Since the capacitance of the board is much greater than that of the ICs, the board-level CDM ESD event may occur when electric charges accumulated on the board are discharged to ground through pins of the ICs, resulting in damage to the IC pins.

Examples of conventional techniques for providing ESD protection for connectors or printed circuit boards (“PCBs”) include U.S. Pat. Nos. 6,447,316, 6,193,555 and 6,407,895 (hereinafter the '316, '555 and '895 patents, respectively). The '316 patent to Jon, entitled “Method to Eliminate or Reduce ESD on Connectors,” discloses a central grounding strip formed in a connector to improve ESD robustness. The '555 patent to Chang, entitled “ESD and Crosstalk Protected Hybrid Connector,” discloses a metallic blade formed in a connector to improve ESD robustness. The '895 patent to Capps, entitled “PWB ESD Discharger,” discloses a printed wiring board (“PWB”) including a discharger for protecting circuit components formed on the board from electrostatic discharge.

The above-mentioned ESD protection techniques for connectors or PCBs, however, are designed to increase ESD immunity of a system against an HBM-like ESD event, and may not provide sufficient protection for the chips under a board-level CDM ESD event. It is thus desirable to provide an interface for CDM ESD protection between circuit systems overcoming at least the aforementioned shortcomings in the art.

### SUMMARY OF THE INVENTION

Accordingly, the present invention is directed to ESD protection interfaces and methods that obviate one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the interfaces and methods particularly pointed out in the written description and claims thereof, as well as the appended drawings.

To achieve these and other advantages, and in accordance with the purpose of the invention as embodied and broadly described, there is provided an interface device coupled to a board on which integrated circuits are mounted for providing electrostatic discharge protection for the integrated circuits that comprises a plurality of first contact members, each of the first contact members including one end connected to the board and the other end to connect to an external device, and at least one second contact member connected to a voltage line of a voltage level, wherein the at least one second contact member includes a length greater than that of each of the first contact members.

In one aspect of the present invention, the first and second contact members further comprise a pin and a receptacle.

In another aspect of the present invention, electric charges accumulated on the board are discharged via the at least one second contact member when the board is coupled to the external device through the interface device.

Also in accordance with the present invention, there is provided an interface device coupled to a board on which integrated circuits are mounted for providing electrostatic discharge protection for the integrated circuits that comprises a plurality of first contact members of a first length, each of the first contact members including one end connected to the board and the other end to connect to an external device, and at least two second contact members of a second length, each of the second contact members being connected to a voltage line of a voltage level, wherein the second length is greater than the first length such that when the board is coupled to the external device through the interface device in a direction, the second contact members contact the external device earlier than the first contact members.

Further in accordance with the present invention, there is provided an interface device formed on a board on which integrated circuits are mounted for providing electrostatic discharge protection for the integrated circuits that comprises a plurality of a first contact lines of a first length, each of the first contact lines including one end connected to the board and the other end to connect to an external device, the one ends of the first contact lines being aligned to an aligning line, at least one second contact line of a second length corresponding to at least one voltage line of a first voltage level to which the integrated circuits are connected, each of the at least one second contact line being connected to a corresponding voltage line at one end aligned with the aligning line, and a third contact line connected to a second voltage level including a third length measured from the aligning line to one end of the third contact line, wherein the second length and the third length are greater than the first length.

Still in accordance with the present invention, there is provided an interface device formed on a board on which integrated circuits are mounted for providing electrostatic discharge protection for the integrated circuits that comprises a plurality of a first contact lines formed near a side of the board, each of the first contact lines including one end connected to the board and the other end to connect to an external device, and at least one second contact line formed near the same side of the board corresponding to at least one voltage line of a voltage level to which the integrated circuits are connected, each of the at least one second contact line including one end connected to a corresponding voltage line and another end connected to the external device.

Yet still in accordance with the present invention, there is provided a detecting system for detecting integrated circuits formed on a board that comprises a test device including a first board, a plurality of first pins formed on the first board, a second board including a first surface and a second surface, a plurality of first contact points formed on the first surface of the second board to receive the first pins, a plurality of second pins formed on the second surface of the second board, and a plurality of second contact points formed on each of the integrated circuits to receive the second pins, wherein electric charges accumulated on the board on which the integrated circuits are formed are discharged from the longer of the first pins and the second pins.

Still in accordance with the present invention, there is provided a method of providing electrostatic discharge protection for integrated circuits formed on a board that comprises providing an interface device including a plurality of first contact members, each of the first contact members including one end connected to the board and the other end to connect to an external device, and at least one second contact member connected to a voltage line of a voltage level, providing the at least one second contact member with a length greater than that of each of the first contact members, coupling the board to the external device through the interface device, and discharging electric charges accumulated on the board via the at least one second contact member.

Still in accordance with the present invention, there is provided a method of providing electrostatic discharge protection for integrated circuits formed on a board that comprises forming a plurality of a first contact lines near a side of the board, providing each of the first contact lines with one end connected to the board and the other end to connect to an external device, forming at least one second contact line near the same side of the board corresponding to at least one voltage line of a voltage level to which the integrated circuits are connected, providing each of the at least one second contact line with one end connected to a corresponding voltage line and the other end connected to the external device, providing the other end of each of the at least one second contact line closer to an edge on the side of the board than the other end of each of the first contact lines, coupling the board to the external device, and discharging electric charges accumulated on the board via the at least one second contact line.

Still in accordance with the present invention, there is provided a method of providing electrostatic discharge protection for integrated circuits formed on a board that comprises forming a plurality of a first contact lines of a first length on the board, providing each of the first contact lines with one end connected to the board and the other end to connect to an external device, aligning the one ends of the first contact lines to an aligning line, forming at least one second contact line of a second length greater than the first length on the board corresponding to at least one voltage line of a first voltage level to which the integrated circuits are connected, providing each of the at least one second contact line with one end aligned to the aligning line, connecting the one end of each of the at least one second contact line to a corresponding voltage line, forming a third contact line connected to a second voltage level, providing the third contact line with a third length measured from the aligning line to one end of the third contact line, the third length being greater than the first length, coupling the board to the external device, and discharging electric charges accumulated on the board via at least one of the third contact line or second contact line.

Still in accordance with the present invention, there is provided with a method of providing electrostatic discharge protection in a detecting system for integrated circuits formed on a board that comprises providing a test device including a first board, forming a plurality of first pins on the first board, providing a second board including a first surface and a second surface, forming a plurality of first contact points on the first surface of the second board to receive the first pins, forming a plurality of second pins on the second surface of the second board, forming a plurality of second contact points on each of the integrated circuits to receive the second pins, providing at least one of the first pins with a length greater than that of the other first pins, or providing at least one of the second pins with a length greater than that of the other second pins, coupling the first pins to the first contact points and the second pins to the second contact points, and discharging electric charges accumulated on the board on which the integrated circuits are formed via the at least one first or second pin of a greater length.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

FIGS. 1A and 1B are respectively a front view and a side view of an interface device for electrostatic discharge (“ESD”) protection in accordance with one embodiment of the present invention;

FIGS. 2A and 2B are respectively a front view and a side view of an interface device for ESD protection in accordance with another embodiment of the present invention;

FIGS. 3A and 3B are drawings that show an interface device for ESD protection in accordance with one embodiment of the present invention;

FIGS. 4A, 4B and 4C are drawings that show an interface device for ESD protection in accordance with another embodiment of the present invention; and

FIGS. 5A and 5B are drawings that illustrate detecting systems provided with functions of ESD protection in accordance with one embodiment of the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

FIGS. 1A and 1B are respectively a front view and a side view of an interface device 10 for electrostatic discharge (“ESD”) protection in accordance with one embodiment of the present invention. Referring to FIG. 1A, interface device 10 includes a plurality of first contact members 12 and at least one second contact member 14 formed in a housing 16. In the present embodiment, interface device 10 includes a male connector 10 including a plurality of pins 14 and 16. Interface device 10 is coupled to a board on which integrated circuits (“ICs”) are mounted. Each of first contact members 12 and second contact member 14 functions to serve as an input/output (“I/O”) terminal to convey signals between the board and an external device (not shown). In a particular embodiment, the external device includes a female connector corresponding to male connector 10.

Referring to FIG. 1B, each of first contact members 12 includes one end 12-2 connected to the board and the other end 12-4 to connect to the external device. Each of the at least one second contact member 14 includes one end 14-2 connected at to a voltage line (not shown) of a voltage and the other end 14-4 to connect to the external device. Each of the at least one second contact member 14 includes a length greater than that of each of first contact members 12. In one embodiment, the at least one second contact member 14 is connected to a reference voltage line such as a VSS line. In another embodiment, the at least one second contact member 14 is connected to a VDD or VCC line. In still another embodiment, the at least one second contact member 14 includes one connected to a VDD line and the other connected to a VSS line.

When the board is coupled to the external device through interface device 10, electric charges accumulated on the board are discharged via the at least one second contact member 14 because each second contact member 14 is longer than each first contact member 12 and would contact the external device earlier than first contact members 12 in a coupling direction. Since the electric charges accumulated on the board are discharged before the board and the external device are completely coupled, the risk of a board-level CDM ESD event is reduced.

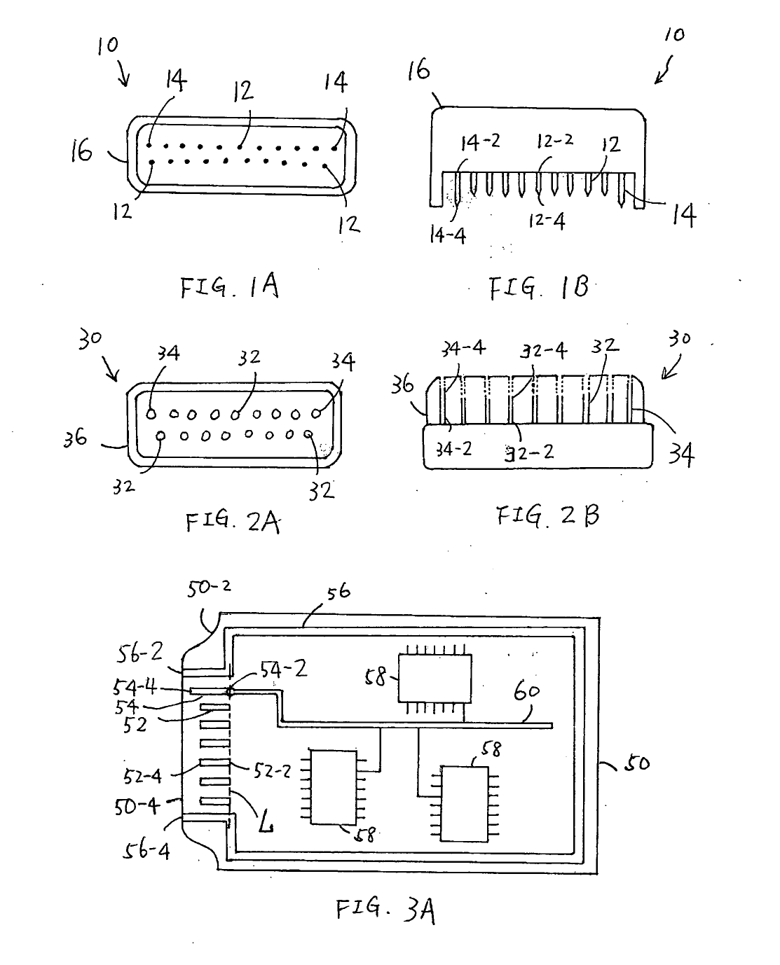

FIGS. 2A and 2B are respectively a front view and a side view of an interface device 30 for ESD protection in accordance with another embodiment of the present invention. Referring to FIG. 2A, interface device 30 includes a plurality of first contact members 32 and at least one second contact member 34 formed in a housing 36. In the present embodiment, interface device 30 includes a female connector 30 including a plurality of receptacles 34 and 36. Interface device 30 is coupled to a board on which ICs are mounted. Each of first contact members 32 and second contact member 34 functions to serve as an I/O terminal to convey signals between the board and an external device (not shown). In one embodiment, the external device includes a male connector corresponding to female connector 30.

Referring to FIG. 2B, each of first contact members 32 includes one end 32-2 connected to the board and the other end 32-4 to connect to the external device. Each of the at least one second contact member 34 includes one end 34-2 connected at to a voltage line (not shown) of a voltage and the other end 34-4 to connect to the external device. Each of the at least one second contact member 34 includes a length or depth greater than that of each of first contact members 32. In one embodiment, the at least one second contact member 34 is connected to a VSS line. In another embodiment, the at least one second contact member 34 is connected to a VDD line. In still another embodiment, the at least one second contact member 34 includes one connected to a VDD line and the other connected to a VSS line.

In operation, when the board is coupled to the external device through interface device 30, electric charges accumulated on the board are discharged via the at least one second contact member 34 because each second contact member 34 is longer than each first contact member and would contact the external device earlier than first contact members 32 in the direction of coupling. Since the electric charges accumulated on the board are discharged before the board and the external device are completely coupled, the risk of a board-level CDM ESD event is advantageously reduced.

FIGS. 3A and 3B are drawings that show an interface device for ESD protection in accordance with one embodiment of the present invention. Referring to FIG. 3A, the interface device (not numbered), formed on a board 50 on which ICs 58 are mounted, includes a plurality of a first contact lines 52, at least one second contact line 54, and a third contact line 56. In one embodiment, each of first, second, and third contact lines 52, 54, and 56 is a gold-plated line formed near a side 50-2 of board 50. Each first contact line 52 includes one end 52-2 connected to internal circuits of board 50 and the other end 52-4 to connect to an external device (not shown). Each of the at least one second contact line 54 includes one end 54-2 connected to one of at least one voltage line 60 of a first voltage level to which ICs 58 are connected, and the other end 54-4 to connect to the external device. Third contact line 56 includes one end 56-2 and the other end 56-4 to connect to the external device. Third contact line 56 is connected to a second voltage level and may be formed around the peripheral of board 50.

In one embodiment, both the first and second voltage levels are VSS. In another embodiment, both the first and second voltage levels are VDD. In still another embodiment, the first voltage level is VDD and the second voltage level is VSS.

In the embodiment shown in FIG. 3A, the one end 52-2 of first contact lines 52 is aligned to an aligning line L illustrated in a dotted line. Each first contact line 52 includes a first length measured from the one end 52-2 to the other end 52-4. Each of the at least one second contact line 54 includes a second length measured from the one end 54-2, aligned to the aligning line L, to the other end 54-4. Third contact line 56 includes a section (not numbered) of a third length measured from the aligning line to one of ends 56-2 or 56-4. The third length and the second length are greater than the first length. Specifically, the third length is greater than the second length, and in turn greater than the first length.

When board 50 is coupled to the external device through the interface device, electric charges accumulated on board 50 are discharged via third contact line 56 before board 50 and the external device are completely coupled to each other.

Referring to FIG. 3B, at least one second contact line 54 includes one (not numbered) connected to a first voltage line 60-2 and the other (not numbered) connected to a second voltage line 60-4. In one embodiment, first voltage line 60-2 is a VDD line and second voltage line 60-4 is a VSS line. The third length is equal to the second length.

When board 50 is coupled to the external device through the interface device, electric charges accumulated on board 50 are discharged via one of third contact line 56 or the at least one second contact line 54. That is, third contact line 56 or the at least one second contact line 54, connected to VDD or VSS, would contact the external device earlier than first contact lines 52 in the direction of coupling. Since the electric charges accumulated on board 50 are discharged before board 50 and the external device are completely coupled, the risk of a board-level CDM ESD event is substantially reduced.

In another embodiment according to the invention, the other end 54-4 of the at least one second contact line 54 and the one end 56-2 or 56-4 of third contact line 56 are disposed closer to an edge 50-4 on side 50-2 of board 50 than the one end 52-2 of each first contact line 52. In a specific embodiment, the one end 56-2 or 56-4 of third contact line 56 is disposed closer to edge 50-4 than the other end 54-4 of the at least one second contact line 54. In another embodiment, both ends 56-2 or 56-4 and 54-4 are aligned to edge 50-4.

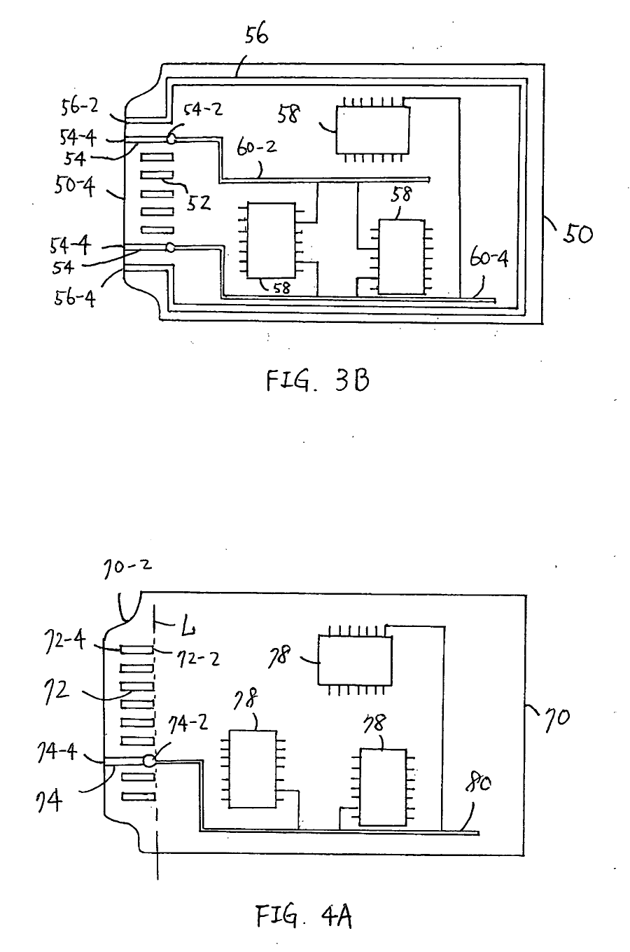

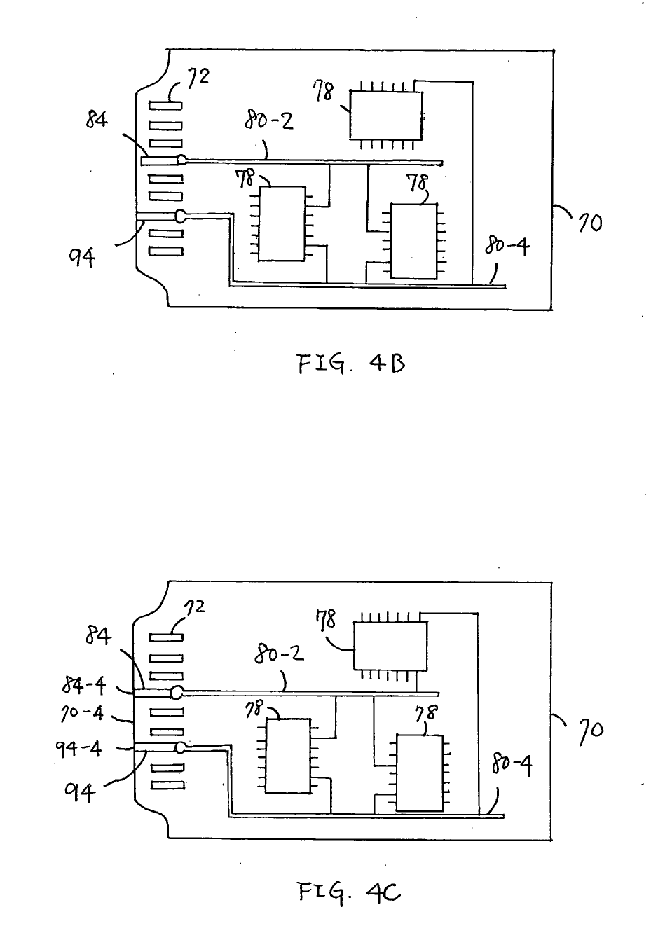

FIGS. 4A, 4B and 4C are drawings that show an interface device for providing ESD protection in accordance with another embodiment of the present invention. Referring to FIG. 4A, the interface device (not numbered), formed on a board 70 on which ICs 78 are mounted, includes a plurality of a first contact lines 72 and at least one second contact line 74. Each of first and second contact lines 72 and 74 is a gold-plated line formed near a side 70-2 of board 70. Each of first contact lines 72 includes one end 72-2 connected to internal circuits of board 70 and the other end 72-4 to connect to an external device (not shown). Each of the at least one second contact line 74 includes one end 74-2 connected to one of at least one voltage line 80 of a voltage level to which ICs 78 are connected, and the other end 74-4 to connect to the external device. In one embodiment, voltage line 80 is a VSS line. In another embodiment, voltage line 80 is a VDD line.

The one end 72-2 of first contact lines 72 and the one end 74-2 of the at least one second contact line 74 are aligned to an aligning line L. Each of first contact lines 72 includes a first length measured from the one end 72-2 to the other end 72-4. Each of the at least one second contact line 74 includes a second length measured from the one end 74-2 to the other end 74-4. The second length is greater than the first length.

When board 70 is coupled to the external device through the interface device, electric charges accumulated on board 70 are discharged via at least one second contact line 74 before board 70 and the external device are completely coupled.

Referring to FIG. 4B, at least one second contact line 74 includes one 84 connected to a first voltage line 80-2 and the other 94 connected to a second voltage line 80-4. In one embodiment, first voltage line 80-2 is a VDD line and second voltage line 80-4 is a VSS line. The one second contact line 84 and the other second contact line 94 include a length greater than the first length. In the example shown in FIG. 4B, the length of the other second contact line 94 coupled to VSS is greater than that of the one second contact line 84 coupled to VDD.

When board 70 is coupled to the external device through the interface device, the other second contact line 94 would contact the external device earlier than the one second contact line 84 and first contact lines 72. Electric charges accumulated on board 70 are therefore discharged via the other second contact line 94.

Referring to FIG. 4C, an end 84-4 of the one second contact line 84 is aligned to an end 94-4 of the other second contact line 94 to edge 70-4 of board 70. As a result, second contact lines 84 and 94 have a same length. In operation, when board 70 is coupled to the external device through the interface device, electric charges accumulated on board 70 are discharged via second contact line 84 or 94.

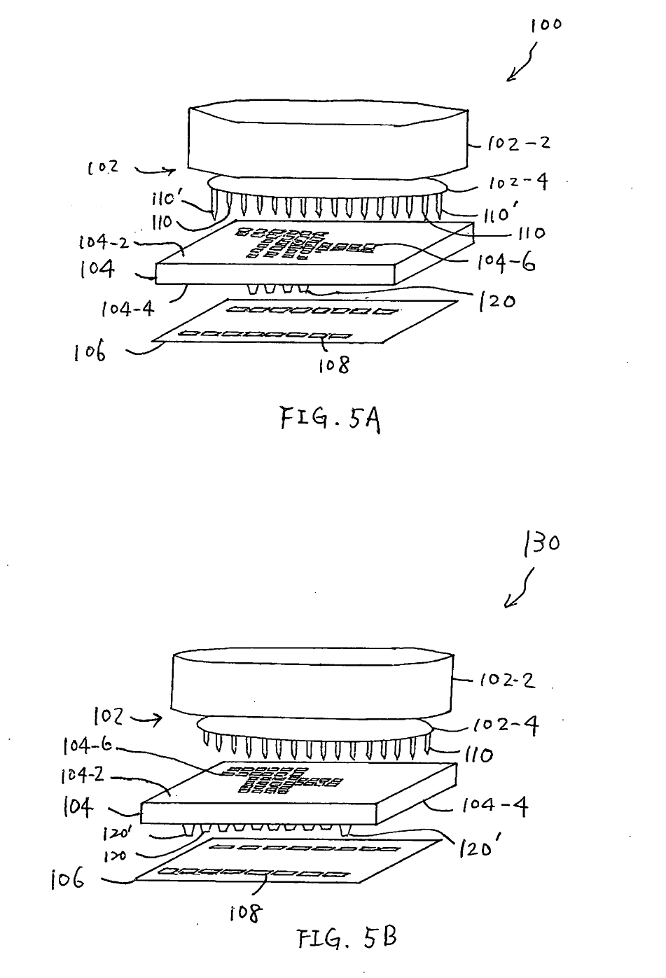

FIGS. 5A and 5B are drawings that illustrate detecting systems provided with functions of ESD protection in accordance with one embodiment of the present invention. Referring to FIG. 5A, a detecting system 100 for detecting ICs includes a tester 102, an interconnect board 104, and a board 106 on which ICs 108 are fabricated. Tester 102 functions to test the ICs still in the form of die on a semiconductor wafer. Tester 102 tests an IC by, for example, sending a sequence of test signals to input terminals of the IC and sampling the output signals produced by the IC to determine whether the IC functions correctly. Tester 102 includes a test head 102-2 and an interface board 102-4. Interface board 102-4 includes a plurality of first contact pins 110 and at least one second contact pin 110′. First and second contact pins 110 and 110′ such as “pogo” pins extend downward from interface board 102-4 to convey signals between test head 102-2 and interconnect board 104. In the example shown in FIG. 5A, second contact pin 110′ is longer than first contact pins 110.

Interconnect board 104 includes a first surface 104-2 and a second surface 104-4. A plurality of contact points 104-6 corresponding to contact pins 110 are formed on first surface 104-2 of interconnect board 104 to receive contact pins 110. A plurality of contact pins 120 such as probe pads are formed on second surface 104-4 of interconnect board 104 to contact input/output (‘I/O”) terminals (not shown), for example, bond pads, of ICs 108. In operation, electric charges accumulated on board 106 on which ICs 108 are formed are discharged from the at least one second contact pin 110′.

A detecting system 130 including a structure similar to that of detecting system 110 is shown in FIG. 5B. Referring to FIG. 5B, detecting system 130 includes interface board 102-4 and interconnect board 104. Interface board 102-4 includes a plurality of contact pins 110 of a uniform length. Interconnect board 104 includes a plurality of first contact pins 120 and at least one second contact pin 120′. In the example shown in FIG. 5B, second contact pin 120′ is longer than first contact pins 120. In operation, electric charges accumulated on board 106 on which ICs 108 are formed are discharged from the at least one second contact pin 120′.

The present invention also provides a method of providing electrostatic discharge protection for integrated circuits formed on a board. In one embodiment, the method includes providing an interface device 10. Interface device 10 includes a plurality of first contact members 12, wherein each of first contact members 12 includes one end 12-2 connected to a board and the other end 12-4 to connect to an external device, and at least one second contact member 14 connected to a voltage line of a voltage level. The at least one second contact member 14 is provided with a length greater than that of each of first contact members 12. The board is coupled to the external device through the interface device, and electric charges accumulated on the board are discharged via the at least one second contact member 14.

In another embodiment, the method includes forming a plurality of first contact lines 52 of a first length on a board 50. Each of first contact lines 52 is provided with one end 52-2 connected to board 50 and the other end 52-4 to connect to an external device. The one ends 52-2 of first contact lines 52 are aligned to an aligning line L. At least one second contact line 54 of a second length greater than the first length is formed on board 50 corresponding to at least one voltage line 60 of a first voltage level to which integrated circuits 58 are connected. Each of the at least one second contact line 54 is provided with one end 54-2 aligned to the aligning line L. The one end 54-2 of each of the at least one second contact line 54 is connected to a corresponding voltage line 60. A third contact line 56 is connected to a second voltage level. Third contact line 56 is provided with a third length measured from the aligning line L to one end 56-2 of third contact line 56, wherein the third length is greater than the first length. Board 50 is then coupled to the external device, and electric charges accumulated on board 50 are discharged via at least one of the third contact line 56 or second contact line 54.

In still another embodiment, the method includes forming a plurality of first contact lines 72 near a side 70-2 of a board 70. Each of first contact lines 72 is provided with one end 72-2 connected to board 70 and the other end 72-4 to connect to an external device. At least one second contact line 74 is formed near the same side 70-2 of board 70 corresponding to at least one voltage line 80 of a voltage level to which integrated circuits 78 are connected. Each of the at least one second contact line 74 is provided with one end 74-2 connected to a corresponding voltage line 80 and the other end 74-4 to connect to the external device. The other end 74-4 of each of the at least one second contact line 74 is disposed closer to an edge 70-4 on the side 70-2 of board 70 than the other end 72-2 of each of first contact lines 72. Board 70 is then coupled to the external device, and electric charges accumulated on board 70 are discharged via the at least one second contact line 74.

In yet another embodiment, the method includes providing a test device 102 including a first board 102-4. A plurality of first pins 110 are formed on first board 102-4. A second board 104 including a first surface 104-2 and a second surface 104-4 is provided. A plurality of first contact points 104-6 are provided on first surface 104-2 of second board 104 to receive first pins 110. A plurality of second pins 120 are formed on second surface 104-4 of second board 104. A plurality of second contact points on each of integrated circuits 108 are provided to receive second pins 120. In accordance with the method, at least one pin 110′ of first pins 110 is provided with a length greater than that of the other first pins 110, or at least one pin 120′ of second pins 120 is provided with a length greater than that of the other second pins 120. First pins 110 are then coupled to first contact points 104-6 and second pins 120 to the second contact points. Electric charges accumulated on a board 106 on which integrated circuits 108 are formed are discharged via the at least one first pin 110′ or second pin 120′ of a greater length.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An interface device coupled to a board on which integrated circuits are mounted for providing electrostatic discharge protection for the integrated circuits, comprising:
a plurality of first contact members, each of the first contact members including one end connected to the board and the other end to connect to an external device; and
at least one second contact member connected to a voltage line of a voltage level,
wherein the at least one second contact member includes a length greater than that of each of the first contact members.

2. The device of claim 1, the first and second contact members further comprising a pin and a receptacle.

3. The device of claim 1, wherein electric charges accumulated on the board are discharged via the at least one second contact member when the board is coupled to the external device through the interface device.

4. An interface device coupled to a board on which integrated circuits are mounted for providing electrostatic discharge protection for the integrated circuits, comprising:
a plurality of first contact members of a first length, each of the first contact members including one end connected to the board and the other end to connect to an external device; and
at least two second contact members of a second length, each of the second contact members being connected to a voltage line of a voltage level;
wherein the second length is greater than the first length such that when the board is coupled to the external device through the interface device in a direction, the second contact members contact the external device earlier than the first contact members.

5. The device of claim 4 wherein each of the first and second contact members includes a pin.

6. The device of claim 4 wherein each of the first and second contact members includes a receptacle.

7. The device of claim 5 wherein the external device includes a different interface device of which each contact member includes a receptacle corresponding to the pin.

8. The device of claim 6 wherein the external device includes a different interface device of which each contact member includes a pin corresponding to the receptacle.

9. The device of claim 4 further comprising VDD or VSS voltage lines.

10. The device of claim 4 wherein the at least two second contact members include one connected to a first voltage line of a first voltage level, and another connected to a second voltage line of a second voltage level smaller than the first voltage level.

11. An interface device formed on a board on which integrated circuits are mounted for providing electrostatic discharge protection for the integrated circuits, comprising:
a plurality of a first contact lines of a first length, each of the first contact lines including one end connected to the board and the other end to connect to an external device, the one ends of the first contact lines being aligned to an aligning line;
at least one second contact line of a second length corresponding to at least one voltage line of a first voltage level to which the integrated circuits are connected, each of the at least one second contact line being connected to a corresponding voltage line at one end aligned with the aligning line; and
a third contact line connected to a second voltage level including a third length measured from the aligning line to one end of the third contact line;
wherein the second length and the third length are greater than the first length.

12. The device of claim 11 wherein the third length is greater than the second length such that when the board is coupled to the external device, and electric charges accumulated on the board are discharged via the third contact line.

13. The device of claim 11 wherein the third length is equal to the second length such that when the board is coupled to the external device, and electric charges accumulated on the board are discharged via at least one of the third contact line or second contact line.

14. The device of claim 11 wherein the first and second voltage levels include VDD or VSS.

15. The device of claim 11 wherein the at least one voltage line includes a VDD line and a VSS line.

16. The device of claim 11 wherein the at least one second contact line is connected to a VDD line.

17. The device of claim 11 wherein the at least one second contact line is connected to a VSS line.

18. The device of claim 11 wherein the at least one second contact line includes one connected to a VDD line and another connected to a VSS line.

19. An interface device formed on a board on which integrated circuits are mounted for providing electrostatic discharge protection for the integrated circuits, comprising
a plurality of a first contact lines formed near a side of the board, each of the first contact lines including one end connected to the board and the other end to connect to an external device; and
at least one second contact line formed near the same side of the board corresponding to at least one voltage line of a voltage level to which the integrated circuits are connected, each of the at least one second contact line including one end connected to a corresponding voltage line and another end connected to the external device.

20. The device of claim 19 further comprising VDD and VSS lines.

21. The device of claim 19 wherein the one end of each of the first contact lines and the at least one second contact line is aligned with each other to an aligning line.

22. The device of claim 21 wherein each of the at least one second contact line includes a second length measured from one end to another end of the second contact line, and each of the first contact lines includes a first length, and the second length is greater than the first length.

23. The device of claim 19 wherein the at least one second contact line includes one connected to a VDD line and another connected to a VSS line.

24. The device of claim 23 wherein the second contact line connected to the VSS line is disposed closer to the edge than the second contact line connected to the VDD line.

25. The device of claim 22 wherein the at least one second contact line includes one connected to a VDD line and another connected to a VSS line.

26. The device of claim 25 wherein the length of the second contact line connected to the VSS line is greater than that of the second contact line connected to the VDD line.

27. The device of claim 25 wherein the length of the second contact line connected to the VSS line is equal to that of the second contact line connected to the VDD line.

28. A detecting system for detecting integrated circuits formed on a board, comprising:
a test device including a first board;
a plurality of first pins formed on the first board;
a second board including a first surface and a second surface;
a plurality of first contact points formed on the first surface of the second board to receive the first pins;
a plurality of second pins formed on the second surface of the second board; and
a plurality of second contact points formed on each of the integrated circuits to receive the second pins,
wherein electric charges accumulated on the board on which the integrated circuits are formed are discharged from the longer of the first pins and the second pins.

29. The system of claim 28 further comprising VDD and VSS lines.

30. The system of claim 28 wherein the at least one longer pin includes one connected to a VDD line and the other connected to a VSS line.

31. A method of providing electrostatic discharge protection for integrated circuits formed on a board, comprising:
providing an interface device including:
a plurality of first contact members, each of the first contact members including one end connected to the board and the other end to connect to an external device; and
at least one second contact member connected to a voltage line of a voltage level;
providing the at least one second contact member with a length greater than that of each of the first contact members;
coupling the board to the external device through the interface device; and
discharging electric charges accumulated on the board via the at least one second contact member.

32. The method of claim 31 further comprising forming each of the first and second contact members in one of a pin or a receptacle.

33. The method of claim 31 further comprising connecting the at least one second contact member to one of a VDD or VSS voltage line.

34. A method of providing electrostatic discharge protection for integrated circuits formed on a board, comprising:
forming a plurality of a first contact lines near a side of the board;
providing each of the first contact lines with one end connected to the board and the other end to connect to an external device;
forming at least one second contact line near the same side of the board corresponding to at least one voltage line of a voltage level to which the integrated circuits are connected;
providing each of the at least one second contact line with one end connected to a corresponding voltage line and the other end connected to the external device;
providing the other end of each of the at least one second contact line closer to an edge on the side of the board than the other end of each of the first contact lines;
coupling the board to the external device; and
discharging electric charges accumulated on the board via the at least one second contact line.

35. The method of claim 34 further comprising connecting the at least one second contact line to one of a VDD or a VSS line.

36. The method of claim 34 further comprising connecting one of the at least one second contact line to a VDD line and connecting the other of the at least one second contact line to a VSS line.

37. The method of claim 36 further comprising providing the second contact line connected to VSS closer to the edge than the second contact line connected to VDD.

38. The method of claim 36 further comprising connecting the other ends of the second contact line connected to VSS and the second contact line connected to VDD to the edge.

39. A method of providing electrostatic discharge protection for integrated circuits formed on a board, comprising:
forming a plurality of a first contact lines of a first length on the board;
providing each of the first contact lines with one end connected to the board and the other end to connect to an external device;
aligning the one ends of the first contact lines to an aligning line;
forming at least one second contact line of a second length greater than the first length on the board corresponding to at least one voltage line of a first voltage level to which the integrated circuits are connected;
providing each of the at least one second contact line with one end aligned to the aligning line;
connecting the one end of each of the at least one second contact line to a corresponding voltage line;
forming a third contact line connected to a second voltage level;
providing the third contact line with a third length measured from the aligning line to one end of the third contact line, the third length being greater than the first length;
coupling the board to the external device; and
discharging electric charges accumulated on the board via at least one of the third contact line or second contact line.

40. The method of claim 39 further comprising discharging electric charges accumulated on the board via the third contact line, wherein the third length is greater than the second length.

41. The method of claim 39 further comprising providing each of the first and second voltage levels with one of VDD or VSS.

42. The method of claim 39 further comprising connecting the at least one second contact-line to one of a VDD or a VSS line.

43. The method of claim 39 further comprising connecting one of the at least one second contact line to a VDD line and the other to a VSS line.

44. A method of providing electrostatic discharge protection in a detecting system for integrated circuits formed on a board, comprising:
providing a test device including a first board;
forming a plurality of first pins on the first board;
providing a second board including a first surface and a second surface;
forming a plurality of first contact points on the first surface of the second board to receive the first pins;
forming a plurality of second pins on the second surface of the second board;
forming a plurality of second contact points on each of the integrated circuits to receive the second pins;
providing at least one of the first pins with a length greater than that of the other first pins, or providing at least one of the second pins with a length greater than that of the other second pins;
coupling the first pins to the first contact points and the second pins to the second contact points; and
discharging electric charges accumulated on the board on which the integrated circuits are formed via the at least one first or second pin of a greater length.

45. The method of claim 44 further comprising connecting the at least one first or second pin of a greater length to one of a VDD or a VSS line.

46. The method of claim 44 further comprising connecting one of the at least one first pin of a greater length to a VDD line and the other to a VSS line.

47. The method of claim 44 further comprising connecting one of the at least one second pin of a greater length to a VDD line and the other to a VSS line.
